(19) United States
(12) Patent Application Publication
(10) Pub. No.: US 2003/0021383 A1
(43) Pub. Date: Jan. 30, 2003

(54) RADIOLUCENT CLIP-ON LIMB POSITIONING SYSTEM FOR X-RAY CASSETTES

(75) Inventors: Marcos V. Masson, Houston, TX (US); Mark H. Henry, Houston, TX (US)

Correspondence Address: Harrison & Egbert, 412 Main Street, 7th Floor, Houston, TX, 77002, US

(73) Assignee: Global Orthopaedics

(21) Appl. No.: 09/916,833

(22) Filed: Jul. 30, 2001

(51) Int. Cl. G03B 42/02

(52) U.S. Cl. 378/177; 378/180; 378/208

(57) ABSTRACT

A radiolucent clip-on limb positioning system for X-ray cassettes maintains a patient's limb and/or extremities in a position on the X-ray cassette without requiring an attendant, thereby eliminating radiation exposure to the attendant. One or more pairs of radioluscent clip members are releasably engaged on the peripheral sides of an X-ray cassette at selective positions and receive and secure the free ends of resilient hold-down bands that extend across the patient's limb and/or limb extremities to resiliently maintain the limb or extremities in a position against the X-ray cassette while obtaining intraoperative radiographs.

### 1. FIELD OF THE INVENTION

This invention relates generally to apparatus for positioning a patient's limb or extremity during X-ray procedures, and more particularly to a radiolucent clip-on limb positioning system for X-ray cassettes that maintains a patient's limb and/or extremities in a position on an X-ray cassette without requiring an attendant, thereby eliminating radiation exposure to the attendant.

### 2. BRIEF DESCRIPTION OF THE PRIOR ART

When taking X-rays of a patient's limb from the hip or shoulder proximally and/or remaining limb distally during surgical procedures (intraoperatively), it is common to place a sterile plastic bag over the X-ray cassette and position the limb and/or extremity on the X-ray cassette. In such situations the patient may be lying on an operating table and may not be conscious or may otherwise be incapable of holding his or her limb in a particular position to be X-rayed. Thus, the patient's limb is usually held still by the physician or an attendant while the X-ray is being taken. However, very often the physician or attendant will move the limb or extremity or hold it improperly to avoid radiation exposure to himself or herself, resulting in a poor or inaccurate X-ray.

While holding the limb and/or extremity against the X-ray cassette, physicians and attendants are often exposed to radiation which, with repeated exposure over extended periods of time, is detrimental to their health.

There are several patents which disclose various hold-down apparatus for use with X-ray cassettes or cassette holders.

Malley, U.S. Pat. No. 5,327,912 discloses an X-ray poser having a sliding carriage to which a patient's forearm and hand may be strapped at a prescribed angle for evaluating carpal tunnel syndrome conditions. An X-ray cassette is removably received in a pair of L-shaped base members beneath the carriage.

Brotzman, U.S. Pat. No. 5,563,926 discloses a frame-like support for an X-ray cartridge which includes a flat base plate to be placed under the leg of a patient that has a series of slots and projections and an L-shaped X-ray cartridge support formed of U-shaped channels at one end of the base plate that support an X-ray cartridge. A patient's foot is supported against the X-ray cartridge and the patient's leg is strapped to the base plate by a tie-down strap formed of a length of gauze or surgical sponge.

The present invention is distinguished over the prior art in general, and these patents in particular by a radiolucent clip-on limb positioning system for X-ray cassettes that maintains a patient's limb and/or extremities in a position on the X-ray cassette without requiring an attendant, thereby eliminating radiation exposure to the attendant. One or more pairs of radioluscent clip members are releasably engaged on the peripheral sides of an X-ray cassette at selective positions and receive and secure the free ends of resilient hold-down bands that extend across the patient's limb and/or limb extremities to resiliently maintain the limb or extremities in a position against the X-ray cassette while obtaining intraoperative radiographs.

### SUMMARY OF THE INVENTION

It is therefore an object of the present invention to provide a clip-on limb positioning system for X-ray cassettes which allows radiographs of limbs to be taken without the need of an attendant or physician to maintain the proper position and thereby completely eliminates radiation exposure to attendants, physicians, and other operating room personnel.

It is another object of this invention to provide a clip-on limb positioning system which is easily and quickly installed on, and removed from, an X-ray cassette.

Another object of this invention is to provide a clip-on limb positioning system for X-ray cassettes which is fully adjustable to allow selective and accurate positioning of a patient's limb or limb extremities relative to an X-ray cassette.

Another object of this invention is to provide a radiolucent clip-on limb positioning system for X-ray cassettes which allows accurate and reproducible radiographs of limbs and extremities to be taken.

A further object of this invention is to provide a radiolucent clip-on limb positioning system having a plurality of resilient bands selectively positionable across a patient's limb or the limb extremities for holding the limb and/or extremities on the top surface an X-ray cassette.

A still further object of this invention is to provide a radiolucent clip-on limb positioning system for X-ray cassettes which is simple in construction, inexpensive to manufacture, and rugged and reliable in operation.

Other objects of the invention will become apparent from time to time throughout the specification and claims as hereinafter related.

The above noted objects and other objects of the invention are accomplished by the present radiolucent clip-on limb positioning system for X-ray cassettes which maintains a patient's limb and/or extremities in a position on the X-ray cassette without requiring an attendant, thereby eliminating radiation exposure to the attendant. One or more pairs of radioluscent clip members are releasably engaged on the peripheral sides of an X-ray cassette at selective positions and receive and secure the free ends of resilient hold-down bands that extend across the patient's limb and/or limb extremities to resiliently maintain the limb or extremities in a position against the X-ray cassette while obtaining intraoperative radiographs.

### BRIEF DESCRIPTION OF THE DRAWINGS

FIG. 1 is a perspective view of an X-ray cassette, shown in dashed line, having a pair of clip members of the clip-on limb positioning system in accordance with the present invention installed thereon and a resilient hold-down band of the system shown above the clips.

FIG. 2 is a side elevation of a clip member in the uninstalled position with the jaws closed.

FIG. 3 is a top plan view of the clip member in the uninstalled position.

FIG. 4 is a perspective view of the clip member shown from the rear end.

FIG. 5 is a perspective view of the clip member shown from the front end.

FIG. 6 is a side elevation of the clip member shown with pressure applied to the finger grip portions and the jaws open.

FIG. 7 is a top plan view showing the hand and fingers of a patient secured palm down on the front surface of an X-ray cassette holder by a number of clips and hold-down bands.

FIGS. 8 and 9 are top plan and side elevation views, respectively, showing a patient's foot secured to the front surface of an X-ray cassette by a number of clips and hold-down bands.

### DESCRIPTION OF THE PREFERRED EMBODIMENT

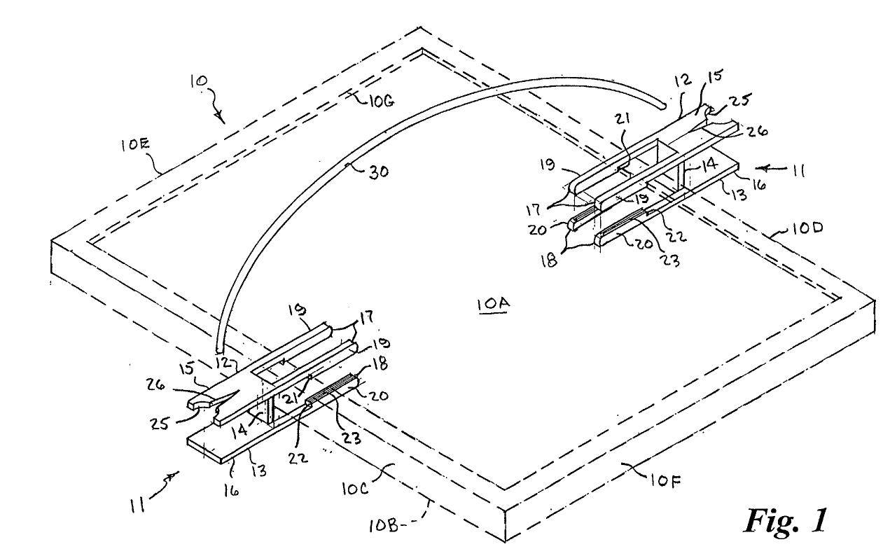

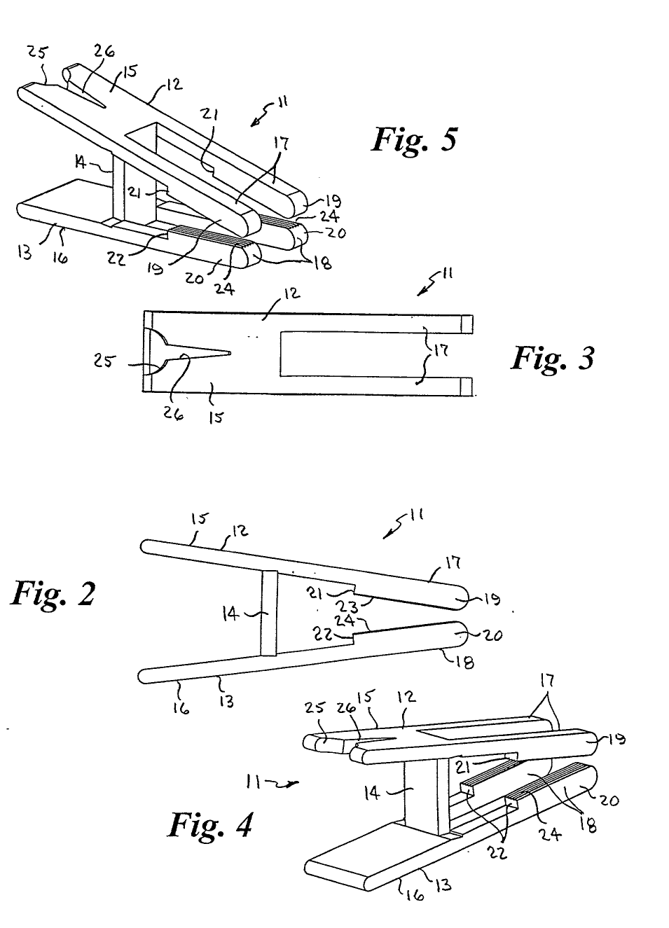

Referring to the drawings by numerals of reference there is shown in FIG. 1, a conventional X-ray cassette 10 represented in dashed line. The conventional X-ray cassette 10 is a generally rectangular member having opposed top and bottom surfaces 10A and 10B, opposed side walls 10C and 10D, and opposed end walls 10E and 10F. The conventional X-ray cassette 10 may also have a raised shoulder 10G or other protuberance that surrounds and extends a short distance above its top surface. In accordance with the present limb positioning system, a plurality of clips 11 and elastic hold-down bands 30 are provided for use with the conventional X-ray cassette holder 10. In FIG. 1, a pair of the clips 11 are shown in the installed position removably engaged on the peripheral sides of the X-ray cassette 10. Referring additionally to FIGS. 2, 3, 4, and 5, a preferred embodiment of a clip member 11 of the clip-on limb positioning system is shown in greater detail. Each clip 11 is formed as a unitary or one-piece construction by conventional means such as injection molding. The clips 11 are formed of a relatively rigid or semi-rigid radiolucent plastic material having a high modulus of elasticity and capable limited flexure. The clips 11 may also preferably be formed of such a plastic that is capable of being sterilized by autoclaving or other suitable sterilization methods.

The clip 11 has a pair of elongate longitudinal lever portions 12,13 interconnected by a generally rectangular web portion 14 which is integrally formed with the lever portions and adjoined thereto at each end. The lever portions 12, 13 each have a flat generally rectangular finger grip portion 15, 16 at one end extending rearward from the web portion 14, and a pair of parallel laterally spaced arms 17, 18 extending forward from the web portion.

The inner facing surface of each arm 17, 18 extends forward a distance from the web portion 14 and terminates in a thicker clasping jaw portion 19, 20 defining a flat raised shoulder 21, 22 spaced a distance forward from the web portion. The shoulders 21, 22 extend transversely across the arms 17, 18. The inner facing surface of each clasping jaw portion 19, 20 has a plurality of parallel longitudinally extending elevated ridges 23, 24 along its length.

The rear portion or finger grip portion 17, 18 of each lever portion 12, 13 is sized to receive a thumb and forefinger of the user on their outer surfaces. The outer surfaces of the finger grip portions 17, 18 may optionally be provided with a rough surface texture to facilitate manual gripping and manipulation. The outer end of the finger grip portion 17 of one lever portion 12 is provided with a semicircular recess 25 and a central elongate V-shaped slot 26 extending longitudinally inward a distance from the recess. As best seen from the side in FIG. 2, when the clip 11 is a relaxed condition, the elongate lever portions 12, 13 converge angularly toward each other from the finger grip portions 17, 18 at their rear ends to the jaw portions 19, 20 at their forward ends and the web portion 14 is in a straight vertical disposition.

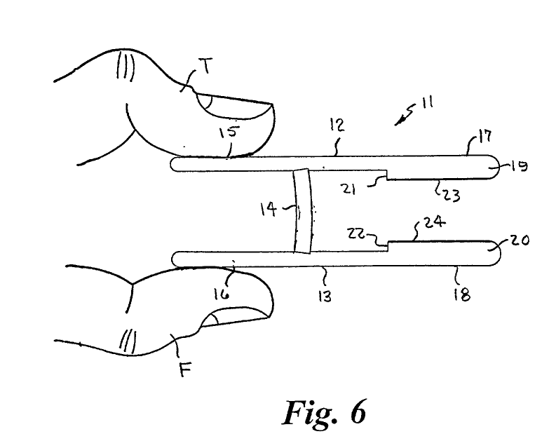

As shown in FIG. 6, to install the clips 11, the user holds the finger grip portions 17, 18 between their thumb T and forefinger F and applies pressure thereto, causing the lever portions 12, 13 to pivot about the web 14, which flexes slightly, thereby forcing the jaw portions 19, 20 apart to an open position to receive the outer edge of the X-ray cassette 10 therebetween. Removal of the pressure on the finger grip portions 19, 20 causes the clip 11 to tend to resume its natural shape thereby allowing the lever portions 12, 13 to pivot about the web 14, which tends to straighten, so that the finger grip portions 17, 18 move apart and the jaw portions 19, 20 engage and grip the top and bottom surfaces 10A, 10B of the X-ray cassette 10 (FIG. 1). Pairs of the clips 11 may be installed in selected locations along the opposed outer sides and/or ends of the X-ray cassette 10.

The hold-down bands 30 are elongate resilient members, such as a length of surgical tubing which is larger in cross section than width of the V-shaped slot 26 in the rear portion of the lever portion 12 of the 11. The hold-down bands 30 may be disposable.

The clip-on limb positioning system is particularly suited for use in taking X-rays in a sterile environment such as an operating room during surgical procedures while a patient is on an operating table. In such situations, the patient may be incapable of holding his or her limb in a particular position to be X-rayed.

After a pair of clips 11 have been installed on the X-ray cassette 10, the patient's limb or extremity to be X-rayed is placed on the face or front surface 10A of the X-ray cassette. The free end of an elastic band 30 is positioned adjacent to the curved recess 25 of one of the clips 11 and then pulled into the narrow V-shaped slot 26 to become wedged therein. The hold-down band 30 is then stretched across the patient's limb or extremity and its free end is pulled into the slot 26 of the other one of the clips 11 to wedge it therein. The clips 11 may be repositioned as required and any number of pairs of clips with a hold-down band for each pair may be used. The tension or tightness, of the band 30 can be adjusted to the particular hold-down requirements by pulling one end of the band out of the slot 26 and stretching or loosening the band and then pulling it back into the slot to wedge it therein. Thus, the hold-down bands 30 stretched across a patient's limb or extremity resiliently bias the limb or extremity against the face or front surface 10A of the X-ray cassette 10, and hold it in the desired position while the X-ray or radiograph is taken.

The longitudinally extending elevated ridges 23, 24 along the length of the inner facing surface of each clasping jaw portion 19, 20 reduces slippage and if the X-ray cassette 10 has a raised shoulder 10G or other protuberance that surrounds and extends a short distance above its top surface, the raised shoulders 21, 22 spaced a distance forward from the web portion 14 will engage the raised shoulder or protuberance on the cassette to prevent the clip from being dislodged accidentally.

It should be noted that once the limb or extremity is properly positioned and secured, it is not necessary for an attendant or physician to hold the limb or extremity against the X-ray cassette while the X-ray or radiograph is taken. Thus, the present clip-on limb positioning system completely eliminates radiation exposure to the attendant or physician.

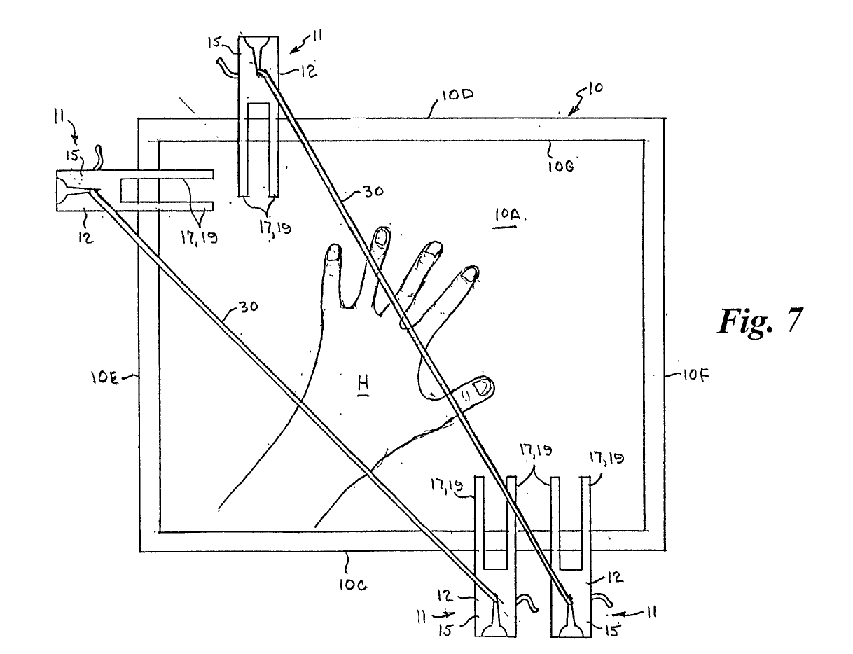

FIGS. 7, 8, and 9 illustrate typical examples of how limbs and extremities may be positioned.

FIG. 7 shows the hand H of a patient secured palm down on the front surface 10A of the X-ray cassette 10 with the fingers spread apart by a plurality of clips 11 and resilient hold-down bands 30.

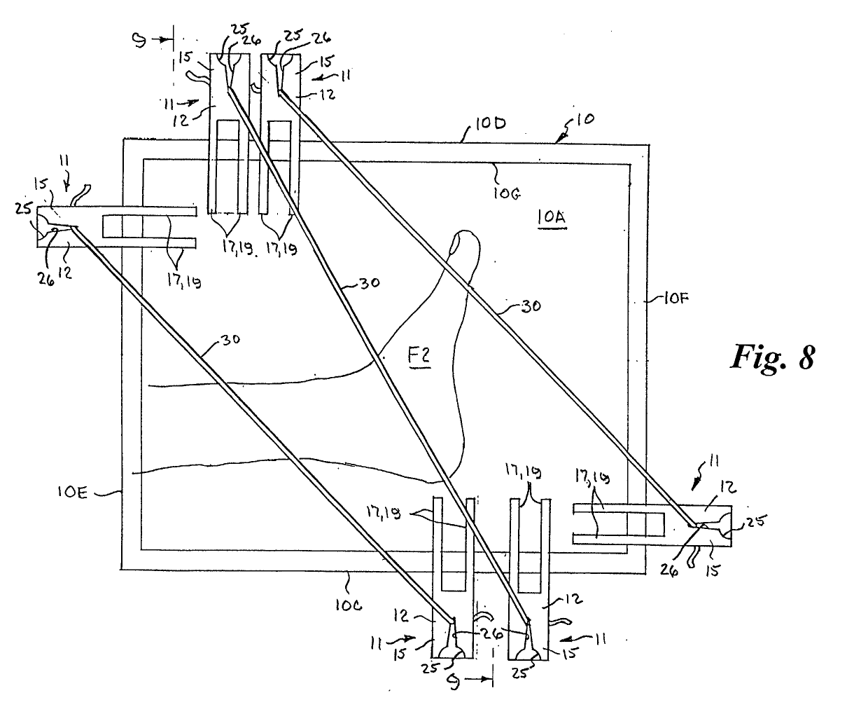

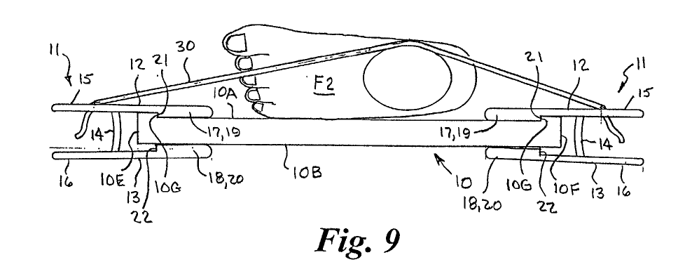

FIGS. 8 and 9 are front and side elevation views, respectively, showing a patient's foot F2 maintained on the front surface 10A of the X-ray cassette 10 by a number of clips 11 and bands 30.

While this invention has been described fully and completely with special emphasis upon preferred embodiments, it should be understood that within the scope of the appended claims the invention may be practiced otherwise than as specifically described herein.

What is claimed is:

1. A clip-on limb positioning system for maintaining a patient's limb and/or the limb extremities in a position on the front surface of an X-ray cassette without requiring an attendant, comprising:
a plurality of clips each sized and shaped to be releasably engaged at a selective location along a side portion of the X-ray cassette, and each having band receiving means for releasably receiving and engaging a free end of a resilient band; and
a plurality of resilient bands each capable of extending across said patient's limb and/or limb extremities and having opposed free ends capable of being releasably engaged with said band receiving means of respective pairs of said clips to resiliently maintain said limb and/or limb extremities on the front surface of the X-ray cassette during radiation without requiring an attendant, thereby eliminating radiation exposure to the attendant.

2. The limb positioning system according to claim 1, wherein
each said clip is formed of radiolucent material.

3. The limb positioning system according to claim 1, wherein
each said clip is formed of autoclavable material.

4. The limb positioning system according to claim 1, wherein
each said resilient band has a length and is capable of being releasably engaged with said band receiving means at selective positions along its length to adjust the tension at which said limb and/or limb extremities is resiliently maintained on the front surface of the X-ray cassette.

5. The limb positioning system according to claim 1, wherein
each of said resilient bands is formed of a length of surgical tubing.

6. The limb positioning system according to claim 1, wherein
each said clip is a one-piece spring clip having first and second relatively stiff elongate lever portions, each lever portion including a finger grip portion at a rearward end thereof, a jaw portion at a forward end thereof, and a web portion joining said lever portions intermediate their ends, the web portion forming a pivot for said lever portions;
said band receiving means is disposed at an outer end of one of said lever portions; and
said jaw portions are disposed in a normally closed position converging toward each other and, upon pressure applied on said finger grip portions, pivot away from each other about said web portion to an open position for insertion onto a side portion of the X-ray cassette, and upon relaxation of pressure on said finger grip portions said jaw portions are resiliently biased into clamping engagement on said X-ray cassette.

7. The limb positioning system according to claim 6, wherein
each of said jaw portions comprise a pair of elongate parallel laterally spaced arms extending forwardly from said web portion.

8. The limb positioning system according to claim 6, wherein
said first and second finger grip portions are of generally rectangular configuration, and
said band receiving means comprises a V-shaped slot with converging sides extending longitudinally inward a distance from an outer end of one said finger grip portions.

9. The limb positioning system according to claim 7, wherein
each said resilient band has a length and is capable of being releasably engaged with said V-shaped slot at selective positions along its length to adjust the tension at which said limb and/or limb extremities is resiliently maintained on the front surface of the X-ray cassette.

10. The limb positioning system according to claim 8, wherein
each of said resilient bands is formed of a length of surgical tubing larger in cross section than the converging sides of said V-shaped slot, and
either of said free ends of said surgical tubing is engaged by manually pulling it into said V-shaped slot so as to wedge it therein, and is disengaged therefrom by manually pulling it out of said V-shaped slot.

11. A method for maintaining a patient's limb and/or the limb extremities in a position on the front surface of an X-ray cassette without requiring an attendant, comprising the steps of:
releasably attaching at least one first and second clip at selective locations along opposed or adjacent side portions of an X-ray cassette, respectively, each said clip having band receiving means for releasably receiving and engaging a free end of a resilient band;
placing the patient's limb and/or the limb extremities to be X-rayed on the front surface of the X-ray cassette;
releasably engaging a first end of a resilient band with said band receiving means of said first clip;
extending said resilient band across said patient's limb and/or limb extremities; and
releasably engaging a second end of said resilient band with said band receiving means of said second clip; whereby
said patient's limb and/or limb extremities are resiliently maintained on the front surface of the X-ray cassette, without requiring an attendant, for exposure to radiation, thereby eliminating radiation exposure to the attendant.

12. The method according to claim 11, comprising the step of
after releasably engaging said second end of said resilient band with said band receiving means of said second clip;
adjusting the tension at which said limb and/or limb extremities is resiliently maintained on the front surface of the X-ray cassette, as required, by disengaging either of said first or second end of said resilient band from either of said band receiving means, stretching or loosening said resilient band to decrease or increase the length of the portion extending across said patient's limb and/or limb extremities; and thereafter
re-engaging said first or second end of said resilient band with said band receiving means.

13. The method according to claim 12, wherein
said band receiving means of each of said clips comprises a V-shaped slot extending longitudinally inward a distance from an outer end thereof; and
said steps of engaging and re-engaging said first and second ends of said resilient band with said band receiving means is accomplished by manually pulling said first or second end into said V-shaped slot so as to wedge it therein, and said step of disengaging either of said first and second ends of said resilient band from said band receiving means is accomplished by manually pulling it out of said V-shaped slot.
